(19) United States
(12) Patent Application Publication
(10) Pub. No.: US 2015/0127814 A1
(43) Pub. Date: May 7, 2015

(54) Monitoring Server Method

(71) Applicants: Inventec (Pudong) Technology Corporation, Shanghai (CN); INVENTEC CORPORATION, Taipei City (TW)

(72) Inventors: Peng HU, SHANGHAI (CN); Xi-Lang ZHANG, SHANGHAI (CN)

(73) Assignees: INVENTEC CORPORATION, Taipei City (TW); Inventec (Pudong) Technology Corporation, Shanghai (CN)

(21) Appl. No.: 14/148,734

(22) Filed: Jan. 7, 2014

(30) Foreign Application Priority Data
Nov. 7, 2013 (CN) 201310548847.9

(51) Int. Cl. H04L 12/26

(52) U.S. Cl. CPC H04L 43/12
USPC 709/224

(57) ABSTRACT

A monitoring server method includes the following steps. First, the baseboard management controller (BMC) receives the running status information of a system device transferred by the system management software. Then, the BMC determines whether or not the system device is operated in a normal state. When the system device is operated in an unusual state, the virtual sensor data record in the sensor data recorder is set in an abnormal state by the BMC. Then, the BMC generates an event according to the abnormal state to trigger a platform event filter (PEF) of the BMC to issue a warning signal to a remote management host.

### RELATED APPLICATIONS

This application claims priority to Chinese Application Serial Number 201310548847.9, filed Nov. 7, 2013, which is herein incorporated by reference.

### BACKGROUND

1. Field of Invention

The invention relates to a monitoring method, and particularly relates to a monitoring server method.

2. Description of Related Art

With rapid development of network technology, the function of the server system is becoming more and more powerful in recent years. In order to enable effective monitoring of operation conditions of various components on a server system, a baseboard management controller (BMC) is used to monitor various operations of the server system and transfer a monitoring result to a management module.

The BMC is an independent sub-system in the server system. In other words, the work of the BMC does not rely on the processor, BIOS or operation system of the server system. When the server system is connected to a power supply. the BMC is kept in a work state regardless of the states of the server system in, on state or standby state. Typically, the BMC monitors the running status of system devices in the server system by acquiring the information, such as temperature and voltage, sensed by sensors disposed in the server system. However, not all the running status of system devices can be monitored by the BMC and not all the system devices can be equipped with sensors to monitor their running status.

Therefore a new monitoring server method to monitor the running status of the server system in real time is needed.

### SUMMARY

An aspect of the invention provides a monitoring server method for monitoring a server system. First, a system management software is provided. The system management software is operated in an operation system of the server system. The system management software monitors a running status information of a system device in the server system to generate a running status information. Then, the running status information is transferred to a baseboard management controller (BMC) of the server system by the system management software. Next, the BMC determines whether or not the system device is operated in a normal state. The BMC includes a sensor data recorder with a virtual sensor data record. When the system device is operated in an unusual state, the virtual sensor data record is set in an abnormal state by the BMC. The BMC generates an event according to the abnormal state. The BMC includes a platform event filter (PEF). The event triggers the PEF to issue a warning signal to a remote management host.

In an embodiment, the running status information is transferred to the baseboard management controller by the system management software through an OEM command. The virtual sensor data record is a sensor data record matching an IPMI (Intelligent Platform Management Interface) rule, and the OEM command is not a standard IPMI command but is a command defined according to the IPMI rule.

In an embodiment, before the baseboard management controller receives the running status information, the sensor data recorder is initialized. The sensor data recorder initialized is to set the virtual sensor data record in an unavailable state.

In an embodiment, the system device is a network device, when the system management software monitors an transmission line of the network device being cut off, the virtual sensor data record is set in the abnormal state by the baseboard management controller, and the event of a transmission line being cut off is triggered and the warning signal of a transmission line being cut off is generated.

In an embodiment, the system device is a hard disc, when the system management software monitors a breakdown in the hard disc, the virtual sensor data record is set in the abnormal state by the baseboard management controller, and the event of a breakdown in the hard disc is triggered and the warning signal of a breakdown in the hard disc is generated.

In an embodiment, the system device is a switching module, when the system management software monitors the server system being shut down by an unusual method, the virtual sensor data record is set in the abnormal state by the baseboard management controller, and the event that the server system is shut down by an unusual method is triggered and the warning signal that the server system is shut down by an unusual method is generated.

In an embodiment, to issue a warning signal to a remote management host further comprises to issue a SNMP (simple network management protocol) Trap signal to the remote management host, or to send an Email to the remote management host.

In an embodiment, to issue a warning signal to a remote management host further comprises to analyze the warning signal by the remote management host.

In view of the above, the running status information of a system device is transferred to the BMC by the system management software through IPMI OEM command. The virtual sensor data record in the sensor data recorder is changed by the BMC according to the running status information to trigger an event. Then, the BMC controls the platform event filter (PEF) to issue a warning signal to the remote management host to perform a remote monitoring process.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic view of a monitoring server apparatus according to an embodiment of the invention.

FIG. 2 illustrates a flow chart of monitoring server method according to an embodiment of the invention.

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

The Intelligent Platform Management Interface (IPMI) is a set of integrated management interface. It not only includes monitoring system circuits of each individual host, but also managing many kinds of hardware and software components outside a host. The IPMI helps system administrators to monitor status of various components through networks, such as CPU operation, fan speed, system temperature, voltage, and so on. The general functions provided by IPMI are general purposes for most server equipments, but not for some special needs. In order to fulfill the special needs of different equipments, OEM commands of IPMI are proposed to be designed by different companies to enhance the original functions. The main purpose of this invention is to develop additional monitoring functions of IPMI OEM commands to provide an advanced management for server devices, such as a network card connection port, a hard disc and an power off state of server system.

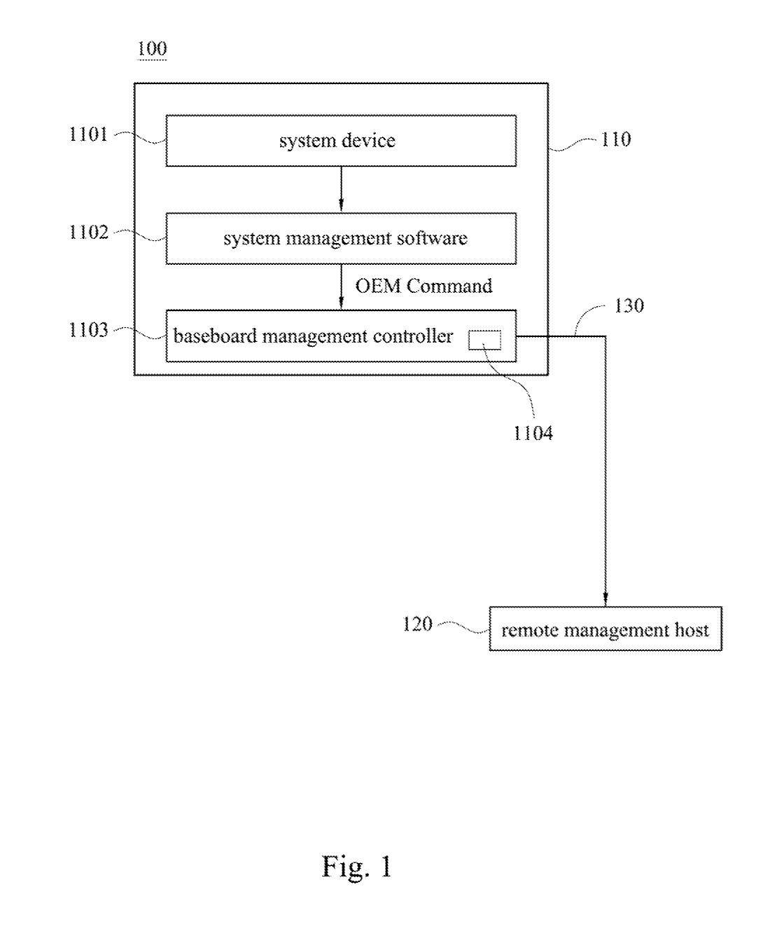

FIG. 1 illustrates a schematic view of a monitoring server apparatus according to an embodiment of the invention. The monitoring server apparatus 100 comprises a server 110 and a remote management host 120. However, in another embodiment, the number of server 110 can be increased. In this embodiment, the server monitoring apparatus 100 may generate a warning message 130 to inform the remote management host 120 when a system device 1101 of the server 100 generate an unusual running status information, such as a network card connection port unusual running status information, a hard disc unusual running status information or an unusual power off state information of server system. Typically, it is impossible to only use a baseboard management controller (BMC) to monitor the above running status information because of limited hardware design. Therefore, an additional system management software is used in the present invention to cooperate with the BMC to monitor the running status information of system device and to issue a warning message when the system device generates an unusual running status information.

In a preferred embodiment, the server 110 further comprises a system device 1101, a system management software 1102 and a baseboard management controller (BMC) 1103. The BMC 1103 further comprises a sensor data recorder 1104. The system management software 1102 is operated in an operation system of the server 110. The system management software 1102 may monitor the running status information of the system device 1101 and generate a corresponding running status information. The running status d information is transferred to the BMC 1103 in the server 110 by the system management software 1102 through the IPMI OEM command. In this embodiment, the official IPMI does not provide the above IPMI OEM command. However, the above IPMI OEM command is designed by a user according to the official IPMI rules. Therefore, the required data and corresponding responses match the IPMI rules. After the BMC 1103 receives the running status information, the BMC 1103 determines whether or not the system device 1101 is operated in a normal state according to the running status information. The sensor data recorder 1104 in the BMC 1103 provides a virtual sensor data record. When the system device 1101 is operated in an unusual state, the virtual sensor data record is set in an abnormal state by the BMC 1103. Then, the BMC 1103 generates an event according to the abnormal state. The event triggers a platform event filter (PEE) of the BMC 1103 to issue a warning signal to the remote management host 120. According to the monitoring method of the present invention, although an OEM command and sensor data record are added in the firmware code of the BMC 1103, the system management software 1102 only needs to gather running status information and transfers the running status information to BMC 1103 through the OEM command. The BMC 1103 is responsible to the following processes. Therefore, the complexity of the system management software 1102 is reduced.

The platform event filter (PEE) generates a predetermined process, such as shutting down the server, resetting the server or issuing an alarm, while the BMC 1103 generates an event. An event filter table in the BMC 1103 is used to set the predetermined processes corresponding to different event contents. When the BMC 1103 receives an event form inside or outside of the server 110, the BMC 1103 compares the event content with that described in the event filter table. Once the event content matches one of the event contents described in the event filter table, a corresponding process is triggered. In an embodiment, a warning message, such as a SNMP Trap matching the simple network management protocol, is issued to inform the remote management host 120 in real time. In another embodiment, the BMC 1103 may send an Email to inform the remote management host 102 The remote management host 120 may correct the unusual state according to the warning message in real time. Because all the sensors used in the present invention are standard type sensors, the virtual sensor data record in the sensor data recorder 1104 matches the IPMI rules. In other words, the event triggered by the abnormal state of the virtual sensor data record also matches the IPMI rules.

Typically, the BMC 1103 monitors the running status of the system devices 110 according to the different types of sensors (not shown in the figure) disposed in the server 110. However, not all running status of the system devices 110 may be monitored by the BMC 1103 through sensors. For solving the above problem, the present invention provides a monitoring method when running status of a system device cannot be sensed by a sensor. In other words, the data in the sensor data recorder 1104 is not a data sensed by a physical sensor. That is, the data in the sensor data recorder 1104 is a data sensed by a virtual sensor. Therefore, this data is called a virtual sensor data record in the present invention. When the system management software 1102 monitors a running status change of a system device 1101, the virtual sensor data record in the sensor data recorder 1104 is also changed. When the change of the virtual sensor data record matches a threshold condition for the sensor data recorder 1104 to trigger an event, the BMC 1103 generates an event.

In an embodiment, the system device 1101 is a network device. The threshold condition for the sensor data recorder 1104 to trigger an event is the unusual transmission state of the network device. For example, the transmission line of the network device is cut off. Accordingly, when the system management software 1102 monitors an unusual transmission state happened in the network device, the virtual sensor data record in the sensor data recorder 1104 is set in an abnormal state by the BMC 1103. Then, an event that the transmission line of the network device is cut off is triggered and a warning message is generated to inform the remote management host 120 that the transmission line of the network device is cut off.

In another embodiment, the system device 1101 is a hard disc. The threshold condition for the sensor data recorder 1104 to trigger an event is that the hard disc is out of order. Accordingly, when the system management software 1102 monitors a breakdown in the hard disc, the virtual sensor data record in the sensor data recorder 1104 is set in an abnormal state by the BMC 1103. Then, an event of a breakdown in the hard disc is triggered and a warning message is generated to inform the remote management host 120 a breakdown in the hard disc.

In further embodiment, the system device 1101 is a switching module of a system. The threshold condition for the sensor data recorder 1104 to trigger an event is that the system is shut down by an unusual method. Accordingly, when the system management software 1102 monitors the system which is shut down by an unusual method, the virtual sensor data record in the sensor data recorder 1104 is set in an abnormal state by the BMC 1103. Then, an event that the system is shut down by an unusual method is triggered and a warning message is generated to inform the remote management host 120 that the system is shut down by an unusual method. In an embodiment, the warning message, such as a SNMP Trap matching the simple network management protocol, is issued to inform the remote management host 120 in real time. The SNMP Trap is a standard Event Report providing the value of one or more instances of management information.

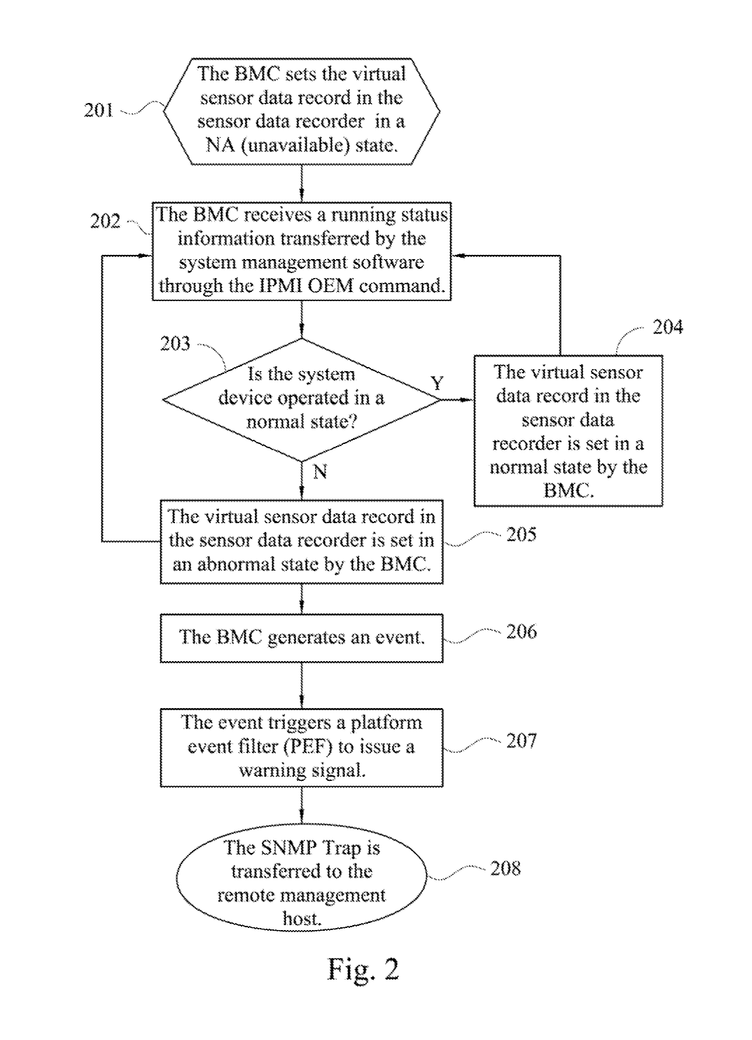

FIG. 2 illustrates a flow chart of monitoring server method according to an embodiment of the invention. Please refer to FIG. 1 and FIG. 2. In step 201, the BMC 1103 sets the virtual sensor data record in the sensor data recorder 1104 in a NA (unavailable) state. That is, the sensor data recorder 1104 is initialized to set the virtual sensor data record in a NA (unavailable) state to prevent the BMC 1103 to trigger an event. Next, in step 202, the BMC 1103 receives running status information transferred by the system management software 1102 through the IPMI OEM command. In an embodiment, the system management software 1102 may monitor the running status information of the system device 1101 and generate a corresponding running status information. The running status information is transferred to the BMC 1103 by the system management software 1102 through the IPMI OEM command. In step 203, whether or not the system device 1101 is operated in a normal state is determined. In an embodiment, after the BMC 1103 receives the running status information, the BMC 1103 determines whether or not the system device 1101 is operated in a normal state according to the running status information. When the system device 1101 is operated in a normal state, the virtual sensor data record in the sensor data recorder 1104 is set in a normal state by the BMC 1103 in step 204. In contrast, when the system device 1101 is operated in an unusual state, the virtual sensor data record in the sensor data recorder 1104 is set in an abnormal state by the BMC 1103 in step 205. Then, in step 206, the BMC 1103 generates an event according to the abnormal state. In step 207, the event triggers a platform event filter (PEF) to issue a warning signal, such as a SNMP Trap. In step 208, the SNMP Trap is transferred to the remote management host 120. In an embodiment, when the sensor data recorder 1104 triggers the BMC 1103 to issue an event, the BMC 1103 controls the platform event filter (PEF) to issue a warning signal, such as a SNMP Trap, to the remote management host 120 according to this event. The remote management host 120 may know which system device 1101 is in an unusual running status by analyzing the SNMP Trap. Then, the remote management host 120 may correct the unusual running status of the system device in real time,

In view of the above, the running status information of a system device is transferred to the BMC by the system management software through. IPMI OEM command. The virtual sensor data record in the sensor data recorder is changed by the BMC according to the running status information to trigger an event. Then, the BMC controls the platform event filter (PEF) to issue a warning signal to the remote management host to perform a remote monitoring process according to this event.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall he defined by the appended claims.

What is claimed is:

1. A monitoring server method for monitoring a server system, comprising:
providing a system management software, wherein the system management software is operated in an operation system of the server system, and the system management software monitors an running status information of a system device of the server system to generate an running status information;
transferring the running status information to a baseboard management controller of the server system by the system management software;
determining whether or not the system device is operated in a normal state by the baseboard management controller according to the running status information:
providing a virtual sensor data record by a sensor data recorder, wherein the sensor data recorder is disposed in the baseboard management controller, and the virtual sensor data record corresponding to the system device; when the system device is operated in an unusual state, the virtual sensor data record is set in an abnormal state by the baseboard management controller;
generating an event by the baseboard management controller according to the abnormal state; and
triggering a platform event filter (PEF) of the baseboard management controller by the event to issue a warning signal to a remote management host.

2. The monitoring server method of claim 1, wherein the running status information is transferred to the baseboard management controller by the system management software through an OEM command.

3. The monitoring server method of claim 2, wherein the virtual sensor data record is a sensor data record matching an IPMI (Intelligent Platform Management Interface) rule, and the OEM command is not a standard IPMI command but is a command defined according to the IPMI rule.

4. The monitoring server method of claim 1, wherein before the baseboard management controller receives the running status information, the sensor data recorder is initialized,

5. The monitoring server method of claim 4, wherein the sensor data recorder is initialized is to set the virtual sensor data record in an unavailable state.

6. The monitoring server method of claim 1, wherein the virtual sensor data record is not related to a sensor data of a physical sensor in the server system

7. The monitoring server method of claim 1, wherein the at least one system device is a network device; when the system management software monitors an transmission line of the network device being cut off, the virtual sensor data record is set in the abnormal state by the baseboard management controller, and the event of a transmission line being cut off is triggered and the warning signal of a transmission line being cut off is generated.

8. The monitoring server method of claim 1, wherein the at least one system device is a hard disc; when the system management software monitors a breakdown in the hard disc, the virtual sensor data record is set in the abnormal state by the baseboard management controller, and the event of a breakdown in the hard disc is triggered and the warning signal of a breakdown in the hard disc is generated.

9. The monitoring server method of claim 1, wherein the at least one system device is a switching module; when the system management software monitors the server system being shut down by an unusual method, the virtual sensor data record is set in the abnormal state by the baseboard management controller, and the event that the server system is shut down by an unusual method is triggered and the warning signal that the server system is shut down by an unusual method is generated.

10. The monitoring server method of claim 1, wherein to issue a warning signal to a remote management host further comprises to issue a SNMP (simple network management protocol) Trap signal to the remote management host, or to send an Email to the remote management host.

11. The monitoring server method of claim 1, wherein to issue a warning signal to a remote management host further comprises to analyze the warning signal by the remote management host.
